(19) United States
(12) Patent Application Publication
(10) Pub. No.: US 2003/0151005 A1
(43) Pub. Date: Aug. 14, 2003

(54) Energy finding technique and typical useful device

(76) Inventor: Ralph E. Bucknam, Huntington, NY (US)

Correspondence Address: BUCKNAM AND ARCHER, 1077 NORTHERN BOULEVARD, ROSLYN, NY, 11576, US

(21) Appl. No.: 10/066,847

(22) Filed: Feb. 4, 2002

(51) Int. Cl. G21G 4/00

(52) U.S. Cl. 250/493.1

(57) ABSTRACT

The disclosure recognizes that the quantity −½ mv² of kinetic energy representing Newton's 3^{rd} law “equal and opposite reaction” not Einstein's E=mc² “rest energy” which completely obscures such energy truly represents available decay energy. A simple example of a device utilizing this kinetic energy as found in nature is provided to demonstrate this distinction, and a mathematical explanation is given of the new way to approach the energy problem.

### BACKGROUND

1. Field of Invention

Exploration of newly opening realm of useful decay energy.

2. Description of Related Art

Aside from well-known combustion processes, the main field of exploration heretofore has been use of alpha, beta, gamma and x-ray radiation from radioactive substances.

### BRIEF SUMMARY OF INVENTION

According to the present invention a proposal is made to explore the vast realm of elements, isotopes and compounds yielding exothermic or other forms of decay energy with the goal of isolating energy yields fitting specific needs and developing devices or components capable of storing such decay energy and delivering it in useful form to utilizing devices or other energy utilizing components, the expectation being that, when the rate of energy decay falls below some set minimum, the energy yielding substance will be replaced. Merely for initial guidance, a figurative display in the form of a motor-generator-battery system has been provided to suggest how the inherent magnetism in lodestone might be employed to operate a very tiny vehicle.

### VIEWS OF DRAWINGS

FIG. 1 represents a graphic explanation of Newton's 3^{rd} law.

FIGS. 2(A) and (B) reveal the energy distortion of E=mc².

FIG. 3 suggest a very simple technique for exploitation.

FIG. 4 is the standard magnification curve.

FIG. 5 shows a 2ⁿ graph and table.

FIG. 6 shows a simple graph of the 1-2 octave.

FIG. 7 shows the algebra-logarithm first level of 2ⁿ.

FIG. 8 shows the dynamic 2ⁿ system and quantum relationships.

FIG. 9 shows Periodic Table property distribution.

FIG. 10 shows the eⁿ log system.

FIG. 11 shows vectorially the non-inertial quantum system.

FIG. 12 shows graphically the representation of isotopes.

FIG. 13 shows a typical display of the isotopes.

FIGS. 14 A and B compare the battery energized and Lodestone systems.

### DETAILED DESCRIPTION

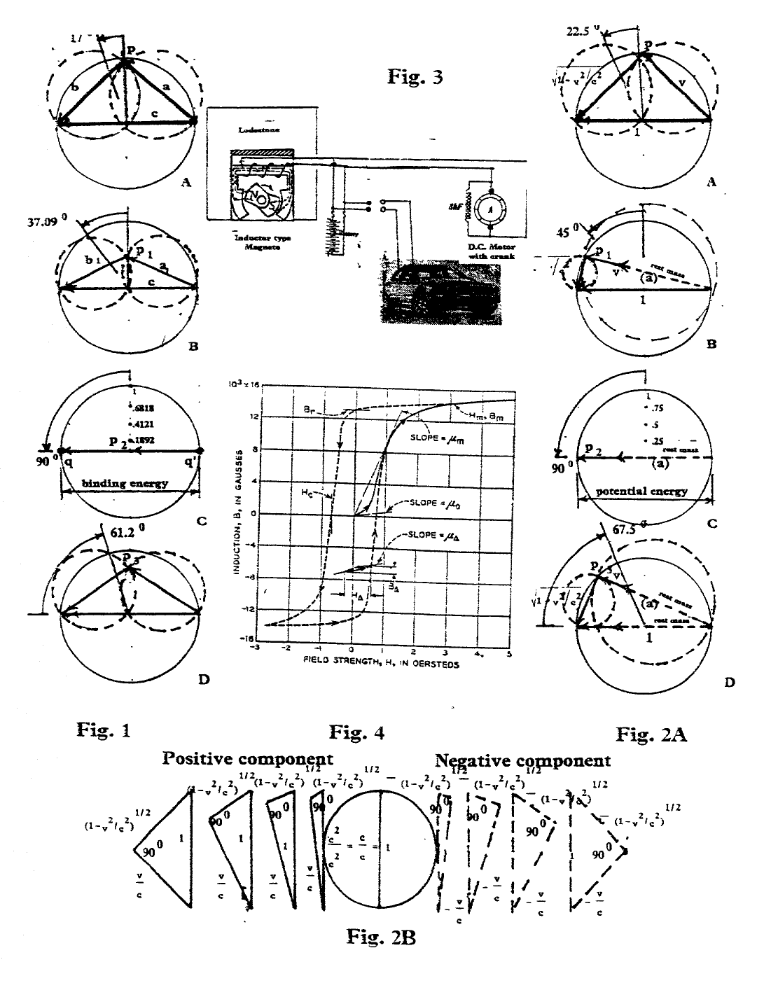

FIG. 1 shows stages A, B, C and D of the operation of Newton's 3^{rd} law on a particle p which is free from gravitational capture in view A and is completely bound by gravitational capture in view C.

One may look at vector a as representing the action force and vector b as representing the equal and opposite reaction force. When particle p is completely free from gravitational capture, vector a equals vector b and their intersection forms a right angle. The energy associated with vector a may be treated as +½ mv² and the energy associated with vector b may be treated as −½ mv², simply because a points upwardly and b points downwardly. The sum of the energy of the two vectors is mv², energy being a scalar quantity independent of direction.

As the gravitational bonding process develops so that both vector a and vector b lose some of the kinetic form of energy and become shorter, as can be seen from view B, the “equal and opposite” state continues, but the intersecting angle at p₁ becomes larger than a right angle.

When the gravitational bonding is complete so there is no longer kinetic energy, as seen at p₂ in view C, the vector equality continues but in a straight line relationship.

When, say through energy decay, the gravitational grip is lost on a part of p, the vectors again begin to represent kinetic energy, as seen at p₃ in view D, but the equal and opposite relationship continues to prevail.

Now we chance upon an interesting new concept: the circular version of the Pythagorean theorem stated as “The area of the circle on the hypothesis is equal to the sum of the areas of the circles with the legs of a right triangle as diameters”. In terms of view A this can be stated mathematically as follows:

π/4_{c}²=π/4ₐ²+π/4_{b}² (1)

Note that views B, C and D disclose the doubly periodic system of traditional mathematics where while the two dash circles of view A yield the full line circle, the point p₁ established by the intersection of the dash circles in view B indicate the height of the minor axis of an ellipse and the point p₂ in view C shows a straight line as the degeneration of the ellipse. The point p₃ in view D shows the re-establishment of the ellipse.

Einstein introduced the concept of “rest energy” or E=mc² in a 1911 paper⁽¹⁾. He taught that when a body is lowered from S₂ to S₁, the gravitational mass M is changed to M′ and “by principles of energy”

M′−=E/c² (2)

(1) THE INFLUENCE OF GRAVITATION ON THE PROPAGATION OF LIGHT, Einstein,

his conclusion was derived on the basis of Special Relativity⁽²⁾ which hinges on the so-called Lorentz transform \sqrt{1−v²/c²}, which (incorrectly) concludes that the velocity of light c is an asymptotic constant represented as the fastest achievable value. Throughout his career, Einstein was careful never to explain his concept in the simple graphic terms now demonstrated in FIG. 2A. View A of that drawing is the same as view A of FIG. 1. Both represent the state where particle p is free of gravitational capture. The energy at our starting point may be regarded as entirely in kinetic form. Annalen der Physik, 35, 1911 (English-Dover). (2) ON THE ELECTRODYNAMICS OF MOVING BODIES, Einstein, Annelen der Physik, 1905, (English-Dover).

While Einstein does not mention the circular Pythagorean theorem, he takes advantage of it in view B of FIG. 2A. What was treated in FIG. 1 as vector b is now designated as \sqrt{1−v²c²}. What was treated as vector a is now designated vector v. The intersection of these two new vectors at p₁ is seen to form a right angle. The two legs of the triangle have again been shown as the diameters of dash circles, and what was vector c has been given the value 1 and shown as the hypotenuse upon which the solid circle is constructed. Here we have shown the velocity vector v having an extended section (a) in dash line and the entire vector has been labeled “rest mass”.

When v=c it will be noted that the Lorentz vector becomes zero and the point p₂ of view C of FIG. 2A falls on the diameter. This means that the “rest mass” or “rest energy” coincides with the diameter. It has been shown again in dash lines extending less than the entire length of the diameter. In present day physics there tends to be a confusion between the terms “potential energy” and “rest energy”. There is no question but the established physics as now practiced allows for only ½ mv² redeemable kinetic energy. The rest is past off as one thing or another, but not as available and usable energy. Thus, when the value of the Lorentz transform moves back up to p₃ in view D, we can either regard this “rest energy” as continuing to lie at rest along the diameter or settle for showing it as a dash line vector which will continue as “rest energy” when it reaches p in view A.

We now come to the obvious flaw in all of Einstein's work. One should write the Lorentz transform as ±\sqrt{1−v²/c²} not −\sqrt{1−v²/c²}. Thus we see that in FIG. 2B Einstein has completely ignored the negative aspect of the energy equation. Had he taken this into account, there would be a second series of Lorentz vectors on the right side of each view in FIG. 2A accounting for the −½ mv² component of kinetic energy.

Einstein's misconception regarding “rest energy” is but the beginning of the problem facing the Scientific Community in the endeavor to find new sources of energy: A fundamental flaw in mathematics and physics can be traced all the way back to Napier and Euler. We must ultimately deal with a distinction between inertial and non-inertial analytical mechanics. An appropriate starting place is the Euler technique which yielded the Naperian eⁿ. This is derived from the binomial theorem in the following way:

Binomial theorem:

$${( a + b )}^{n} = {a}^{n} + {n}_{a}^{n - 1} x + \frac{n ( n - 1 ) {a}^{n - 2}}{2 !} {x}^{2} + \frac{n ( n - 1 ) ( n - 2 ) {a}^{n - 2}}{3 !} {x}^{3} \qquad ( 3 )$$

Euler succeeded in reducing this to:

$${e}^{1} = 1 {\cdot }_{{1}^{0}} + 1 {\cdot }_{{1}^{1}} + \frac{1}{2 !} \cdot {1}^{2} + \frac{1}{3 !} \cdot {1}^{3} + \frac{1}{4 !} \cdot {1}^{4} + \qquad ( 4 )$$

At this point he made the mistake of equation

1⁰=1¹=1²=1³=1⁴+. . .

and (incorrectly) adding the terms as though they were linear or algebraic. This is “adding apples and oranges”. One cannot properly add together an inch, a square inch and a cubic inch. Euler thus incorrectly arrived at:

$${e}^{1} = 1 + 1 + \frac{1}{2 !} + \frac{1}{3 !} + \frac{1}{4 !} + … = 2.71828 \qquad ( 5 )$$

This incorrect result forms the basis for all Euler trigonometry:

$$i sin A = \frac{{e}^{iA} - {e}^{- iA}}{2} , cos A = \frac{{e}^{iA} + {A}^{iA}}{2} \qquad ( 6 )$$

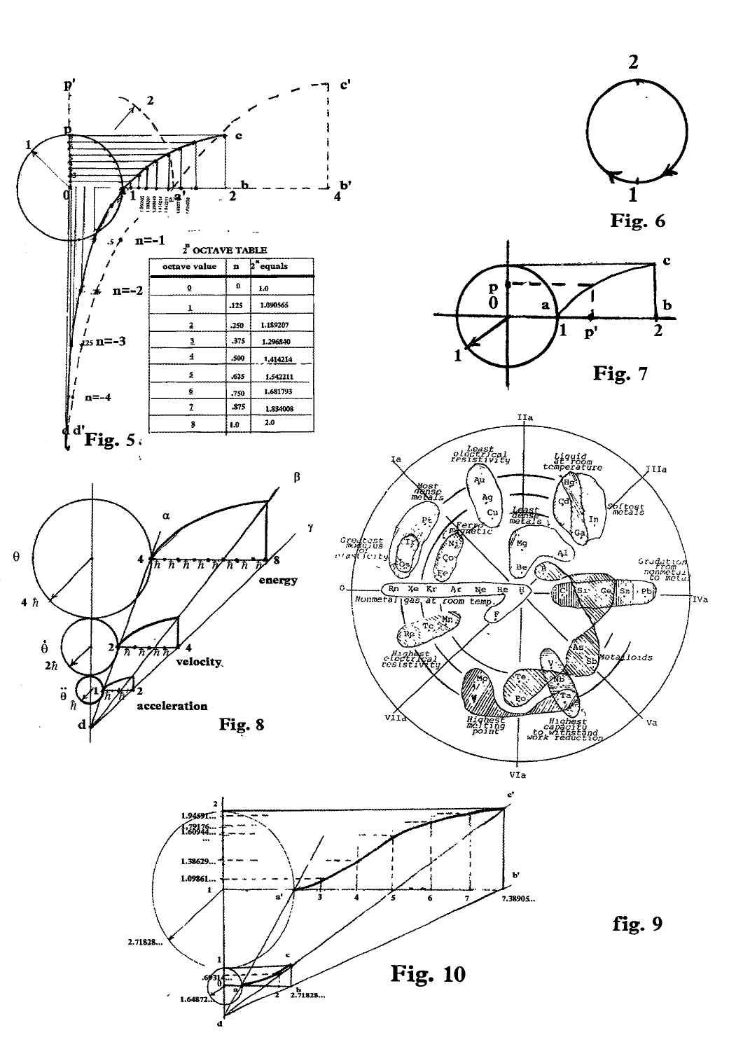

Had Euler not made this mistake he would have arrived at the 2ⁿ “inverse square” law (see FIG. 5).

The inverse square law can be demonstrated with ease in terms of Eq. (7):

(a+b)ⁿ=(1+1)ⁿ=2ⁿ=. . . +8+4+2+1+[0.5+0.25+0.125+. . . 0] (7)

The concept “coming” is when one goes from high numbers to zero. The concept “going” is when one goes from zero to the high numbers.

To understand fully the meaning and operation of the new non-inertial number system one must patiently get to the root of the problem. Other than a digit in numbers such as 10, 100, etc. zero came into its present use only with the introduction of algebra in the 9^{th} century. Indeed, it has been suggested that Napier was the first to move all numbers except zero to one side of an algebraic equation. There is no zero in either the ancient Greek or Roman systems of counting.

While it is a great advantage to drive a stake in the ground and name it “zero”, this meaning is obviously arbitrary. The advantage is that it provides a starting point for measuring or counting. The problem inherent with such use of zero is the inescapable need to define 1/0. Invariably this is interpreted as “infinity”. But what is infinity? We know of no physical phenomenon or dimension (except time) which can reasonably be described as “infinite”. The mathematically correct resolution of the problem resides in the meaning of unity. The number “1” may by definition be given any desired finite size. We can have 1 mouse or 1 elephant. The inescapable conclusion is that space is curved and all lines are re-entrant so that, at some point, they will intersect themselves. While the curve could take any form, it is appropriate to think in terms of the circle. This, in turn, leads to the octave. The simplest circular octave, in terms of primary numbers, is a circle representing “vibration”, if you will, between 1 and 2 as shown in FIG. 6.

Since over the centuries we have developed an enormous wealth of scientific information based on the “zero” or inertial system, it becomes highly desirable that a technique be made available for shifting back and forth between the non-inertial “1” system and the inertial “zero” system. Fortunately, as seen in FIG. 7, this is easily done. Disregarding the strain on logic we can simply say that, inertially speaking, the octave in question involves vibration between 0 and 1. The inter-relationship thus calls for subtracting 1 from each value of FIG. 6 so that true octave 1-2 becomes inertial octave 0-1.

As it happens, this coincides with the relationship known to exist between exponential and algebraic (or linear) values. It is well known that 2⁰=1 and 2¹=2. FIG. 7 shows a standard way to graph this relationship. We first determine the “size” we will use for “1”. We draw the circle at 0 with radius 1. On the x-axis we construct the radius ab whose radius is twice the radius of the circle. We next construct what is commonly known as the logarithmic segment ac and the algebraic or linear ordinate 0 1. The algebraic point p on this ordinate corresponds to the logarithmic value p′ on base ab.

The question “Would the Einstein approach be useful if it included both the positive and negative components of FIG. 2B” can now be answered with precision. It would not.

As shown by the angular values of FIGS. 1 and 2A, here is the reason: Assume the movement from p to p₂ goes through the time intervals 0, 0.25, 0.5, 0.75 and 1.0. As shown in FIG. 2A, the sequential movement will be 90⁰×0.25=22.5⁰, 90⁰×0.5=45⁰, 90⁰×0.75=67.5⁰ and 90⁰×1.0=90⁰. In other words, it will be the (distorted) linear movement.

For the 2ⁿ system one first writes the non-inertial true octave increments 0=1, 0.25=1.1892 . . . , 0.5=1.4142 . . . , 0.75=1.6818 . . . and 1.0=2 from the table in FIG. 5. Next, using the technique developed in connection with FIG. 6, one subtracts unity from each of these values, yielding 0=0, 0.25=0.1892 . . . , 0.5=0.4142 . . . , 0.75=0.6818 . . . and 1.0=1. Thus, the angles as shown in FIG. 1 will be 90⁰×0.1892=17°, 90⁰×4142=37.09⁰, 90⁹×0.6818=61.2⁰ and 90⁰×1=90⁰. This affords a practical example of the operation of the 2ⁿ system.

In Eq. (7) we have shown in brackets

[+0.5+0.25+0.125+. . . 0]

To explain this some additional comments are appropriate regarding the dash-line system 2²=4, with radius 2. The immediate goal of the new non-inertial analytical mechanics is to introduce a new and different approach to quantum mechanics. It should be thought of as “Non-Inertial Quantum Mechanics”. It will be shown that, in this context, r=1= and r=2=2, where is the “Dirac” symbol.

The circle of the 2² system has been shown as having the ordinate Op′. The “useful” new exponential curve has been shown as a′c′, the base as a′b′ and the bracketed residue 0.5 to 0 is shown as the new curve a′d′. It will be appreciated that each new system 2³, 2⁴, etc. will be double the size of the immediately preceding system.

FIG. 8 shows two important aspects of the 2ⁿ system, the dynamic levels and the relationship thereto of the quantum radial unit .

Bear in mind that for v, at the value of acceleration a is averaged (or multiplied by ½) to arrive at velocity. This is the case in the first two levels of FIG. 8. Also for kinetic energy E=½ mv², the value of velocity before squaring being averaged as ½ as shown between the second and third levels. Also, note that the logarithmic critical values fall on three rays, dα, dβ and dγ. Interestingly, as can be seen in FIG. 10, even for the flawed irrational system eⁿ this applies, the numbers shown on the base portions being the primary log numbers. It will be found that all log systems have these rays.

At the turn of the 20th century the correlation of radiation intensity with wavelength became a challenging field of study. The most important work had been done by Lord Rayleigh and Sir James Jeans. In their attempt to study the radiation from a so-called “blackbody”, i.e. a totally enclosed cavity, such as a furnace, maintained at constant temperature, it was expected that radiation would be a function of temperature only, and this would be identical with the radiation which would be emitted by a perfect blackbody at the same temperature T′. The expression ρ_{ν} was developed for energy density or radiation intensity at radiation frequency ν:

ρ_{ν}=8πν²/c²kT (8)

where T is the absolute temperature and c is the velocity of light. Here k is the well-known Boltzmann constant:

k=R/N=PV/TN (9)

in which V is the volume of a mol of gas, R is the “universal gas constant”, N is Avagadro's number and P is pressure. The main difficulty in this work of Rayleigh and Jeans is generally attributed to problems with the Principle of Equipartition of energy. It will be seen from Eq. (8) that energy could be infinite, which is known as “catastrophic” mathematics.

To his very great credit, Max Planck recognized in 1901 that the problem of equipartition could not be circumvented except by a complete departure from classical mechanics. While in full modern perspective what he did amounts to but a primitive first step, it must be acknowledged that he was the first scientist to “raise his head out of Flatland”.

He resorted to probability ratios and introduced the “quantum” Planck which is now recognized as representing the circumference of some chosen circle as the quantum. Throughout the 20^{th} century, and particularly in the 1920s, great strides in the probability direction have been made, most importantly the Schrodinger quantum equation based on the “density probability Ψ*Ψ” which has led to highly useful (but inaccurate) results.

Only when it has become so clear that the 2ⁿ concept fits so very beautifully into the many, many aspects of nature did it become evident that the true meaning of quantum mechanics is the display in FIG. 8.

It is now generally recognized that, in analyzing dynamics, four distinct quantum numbers apply: s=spin, θ=the “polar” dimension, Φ=the “azmuthal” dimension and r (or n)=the radial dimension, all formed on a sphere on the basis of the radius “Dirac h” or a doubled multiple thereof. Until recently, probably due to the fact that probabilities obscures physical meaning, none of these quantum numbers was fully understood. Dirac had, in a complex way arrived at the conclusion that “s” should be plus or minus ½. It had never even been dreamed that the entire “secret” of quantum mechanics has really long ago been disclosed as standard analytical mechanics in numerous well-known text books⁽³⁾. Simply stated, these four quantum numbers find a basis in the following traditional standard analytical mechanics equation: (3) See for example ANALYTICAL MECHANICS (2nd Ed.) Grant R. Fowles, Holt, Rinehart and Winston, p. 132. CLASSICAL MECHANICS (2nd Ed.) Corben and Stehle, Robert E. Krieger Pub. Co. p.145.

$$ω χ \dot{r} = \frac{1}{2} [ \frac{{ⅆ}^{2} R}{{ⅆ}_{{t}^{2}}} - \ddot{r} - \dot{ω} χ r - ω χ ( ω χ r ) ] \qquad ( 10 )$$

In the past, FIG. 11 has served mainly as a demonstration of the geometry for the general case of translation and rotation of the Cartesian coordinate system. Eq. (10) may be explained in terms of that figure. Let 0 represent the origin of an inertial circular system with radius R₀. Let 0₁ represent the origin of a system in which 0₁ is free to rotate around the circumference of 0. Also assume that 0₁ is free to have translation movement along r. Let I, J, and K represent the coordinates of 0 and i, j and k the coordinates of 0₁.

Let us initially assume that r=0, so we have a purely inertial system with neither rotation nor translation of 0₁.

We recognize ωX \dot{r} as the Coriolis force, and with r=0:

$$\pm ω χ \dot{r} = \pm \frac{1}{2} \frac{{ⅆ}^{2} R}{{ⅆ}_{{t}^{2}}} = \frac{1}{2} \frac{{ⅆ}^{2} {R}_{0}}{{ⅆ}_{{t}^{2}}} \qquad ( 11 )$$

Here we recognize a strange fact. While r may be zero, it can still have a potential velocity \dot{r}.

If we set R₀=1, Eq. (11) becomes:

$$Coriolis = \pm ω χ \dot{r} = \pm \frac{1}{2} \frac{{ⅆ}^{2} {R}_{0}}{{ⅆ}_{{t}^{2}}} = \pm \frac{1}{2} = traditional spin \qquad ( 12 )$$

Up until now it has been almost universal to characterize Coriolis as a “fictitious” force or to break it down into two curved components. Now, we see that R₀ is the unit radius, (say ) which yields the spin quantum number s characterizing every particle subject to relative motion with respect to other particles.

The translation movement of 0₁ is representable by

r=ix+jy+kz (13)

Vectorially speaking we find that

R=R₀+r=R₀+ix+jy+kz (14)

Differentiating with respect to time:

$$\frac{ⅆ R}{ⅆ t} = {V}_{0} + i \dot{x} + j \dot{y} + k \dot{z} + x \frac{ⅆ x}{ⅆ t} + y \frac{ⅆ y}{ⅆ t} z \frac{ⅆ z}{ⅆ t} = {V}_{0} + \dot{r} + ω \qquad ( 15 )$$

where \dot{r} is the velocity of r.

$$x \frac{ⅆ x}{ⅆ t} + y \frac{ⅆ y}{ⅆ t} + z \frac{ⅆ z}{ⅆ t} = the velocity due to rotation of i , j , k .$$

the velocity due to rotation of i, j, k.

The sense of angular velocity vector ω is given by the right hand rule. (See FIG. 11).

The part of the velocity of 0₁ which results from the rotation of the i, j, k system is:

So

$$\begin{matrix}\begin{matrix}x \frac{ⅆ x}{ⅆ t} + y \frac{ⅆ y}{ⅆ t} + z \frac{ⅆ z}{ⅆ t} = x ( ω χ i ) + y ( ω χ j ) + z ( ω χ k ) \\ = ω χ ( i x + jy + kz ) = ω χ r\end{matrix} & ( 16 ) \\ \frac{ⅆ R}{ⅆ t} = \dot{r} + ω χ r + {V}_{0} & ( 17 )\end{matrix}$$

The term V₀ is due entirely to the translation movement.

Let q represent any vector in the rotating system. We recognize that

$$\frac{ⅆ q}{ⅆ t} = {q}^{•} + ωχq \qquad ( 18 )$$

Where \dot{q} is the time rate of change in the rotating system ωX q is the time rate of q arising from rotation of the coordinate system.

$$Setting {q}^{•} = \frac{ⅆ r}{ⅆ t} - {V}_{o} = r + ωχr we arrive at . \qquad ( Eq . 10 )$$

We find that the counterpart of centripedal acceleration ωX (ωX r) represents the energy vector pertaining to Ψ.

\ddot{r} represents the distance vector of Φ, and \dot{ω}Xr represents

the orientation vector \ddot{θ}.

The lesson Coriolis teaches, which until now has been ignored, is that no dynamic system in the universe is stationary or inert.

It now becomes very clear that the velocities ω and \dot{r} are in the nature of inherent tendencies predicting a particular response, say for example when the bow is applied to the string. The response may be positive or negative half-spin in a simple singlet system or some combination adding up to a 0 or to a ±1 spin in the triplet state. Spin thus offers a guide to the manner of participation of individual particles in any dynamic combination thereof.

We now come to the challenge facing those who would search for energy in the new direction. They must first divorce their minds from the conviction that it is hopeless to attempt dealing with the multitude of compounds, isotopes and elements which yield no detectable radioactive display in the course of their energy decay.

The promising new course is to analyze the half-lives and physical properties thereof with the goal of tracing specific physical properties suggesting trends which may lead to a desired objective. FIG. 9 has been copied from my treatise THE IMPARTIAL EYE(⁴). It shows in terms of the Periodic Table various properties of elements as known in 1978. (4) © Ralph E. Bucknam, No. Tx-1 filed Jan. 2, 1978.

Profiting from what has now been explained about non-inertial quantum mechanics, researchers can plot spheres with radii determined by , 2, 4, etc. and, using the guidence of FIG. 8, plot the various elements and their isotopes as a basis for organized study of the properties of the various substances including decay time and physical trends.

It has long been recognized that the chemical and physical properties of the elements of the Periodic Table vary in an organized way with their atomic numbers. The variation is in groups which facilitates fitting individual groups into the following TABLE of spherical surfaces using the new non-inertial concept. To avoid complexities at this early stage the Lanthanons and Actinons and some of the newly discovered heavy elements have been omitted. Also, assumptions (not necessarily correct) have been made concerning positive and negative spin to indicate a possible form of compliance with Pauli's Exclusion Principle:

TABLE

| | Quantum | Spin |
|---|---|---|
| Element groups | spin | direction |
| H¹ to Ne¹⁰ | &Hslashed; | + |
| Na¹¹ to Ar¹⁸ | 2 &Hslashed; | + |
| K¹⁹ to Kr³⁶ | 4 &Hslashed; | + |
| (with gaps) | | |
| Sc²¹ to Zn³⁰ | 4 &Hslashed; | − |
| Rb³⁷ to Xe⁵⁴ | 8 &Hslashed; | + |
| (with gaps) | | |
| Y³⁹ to Cd⁴⁸ | 8 h | − |
| Cs⁵⁵ to Rn⁸⁶ | 16 &Hslashed; | + |
| (with gaps) | | |

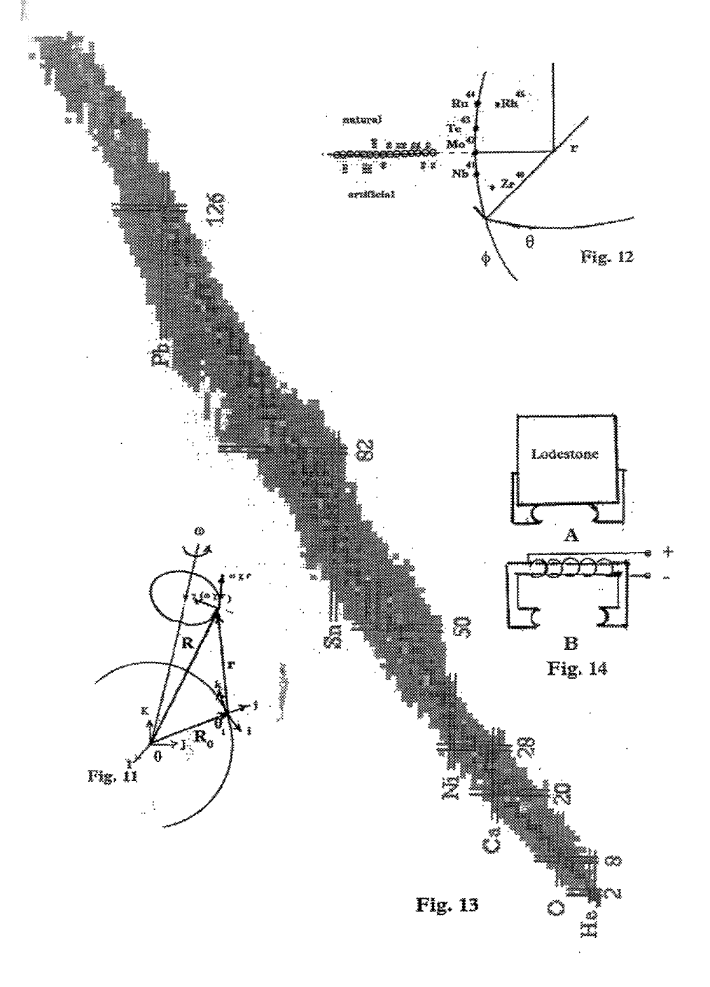

The TABLE would be difficult to understand without some explanation. FIG. 12, which applies to the sixth row Y³⁹ to Cd⁴⁸ gives several examples of the element plotting on the surface of the sphere whose radius is determined by the negative spin quantum 8x as applied to determine R₀ of FIG. 11. Note from the traditional Periodic Table that Zr⁴⁰ has the ring values 4d²5s². This means it will be counted on the Φ circle shown in FIG. 12 because of the 4d² but it will offset in the θ direction one quantum unit because of the 5s² ring position. Nb⁴¹, Mo⁴², Te⁴³ and Ru⁴⁴ will not have the offset θ value because they are in the 5s circle, not the 5s² circle.

FIG. 12 has the primary purpose of demonstrating how the isotopes are representable non-inertially. Mo⁴² has been chosen as an example. It has the following sets of natural and artificial sets of isotopes:

| (natural) | (natural) | (natural) | (natural) | (natural) | (natural) | (natural) |
|---|---|---|---|---|---|---|
| 92 | 94 | 95 | 96 | 97 | 98 | 100 |
| (artificial) | (artificial) | (artificial) | (artificial) | (artificial) | (artificial) | |
| 91 | 93 | 99 | 101 | 102 | 105 | |

Since in each case they have the same quantum numbers Φ and θ as Mo⁴², their energy increases in the r direction only and are representable upon an extension of the spherical radius as shown in FIG. 12.

FIG. 13 shows a Table of Nuclides downloaded from http://sutckh.nd.ac/CoN/ as the work of Jongwha CHANG, Korea Atomic Energy Research Institute. It is believed now to be in very broad use. For example, one variation will be found at page 1003 of “CHEMISTRY, Matter and Its Changes”⁽⁵⁾ published in the year 2000. The display is particularly useful in determining the stability of various elements and their isotopes. One learns that over a thousand isotopes have been made by transmutation, i.e. change of one isotope into another. (5) CHEMISTRY, Matter and Its Change, (3rd Ed.) Brady, Russell, Holum, John Wiley & Sons.

The naturally occurring isotopes above the atomic number 83 all have very long half-lives. At present there are understood to be about 264 known stable isotopes. Particular rules have been developed regarding stability. Only five are known to have odd numbers of both protons and neutrons. Also, 157 have even numbers of both. There is an “odd-even” rule which is related to the spins of nucleons. It has been discovered that, when two protons or two neutrons have paired spins (i.e. opposite spins), their combined energy is less than when the spins are unpaired. The least stable nuclei tend to be those with both an odd proton and an odd neutron.

As shown in FIG. 13, one of the truly fascinating aspects of Chemistry is what are known as the “magic numbers” 2, 8, 20, 28, 50, 82 and 126. When the number of both protons and neutrons is the same magic number, the isotope is very stable. The nucleus is understood to have a shell structure with energy levels analogous to the known electron energy levels.

Now, let us explore the specific problem of implementing the invention. The device of FIG. 3, whether novel per se or not, demonstrates a simple means for extracting useful energy from a substance found in nature. In some instances a manufactured substance may be found useful.

The figures for the magneto, motor and battery of FIG. 3 and the magnetism diagram of FIG. 4 have been copied directly from Van Nostrand's Scientific Encyclopedia (3rd) Edition(1958). Referring to FIG. 14 it will be seen that, traditionally, in producing the magnetic flux for the magneto pole flux is produced as shown at B by an energy source such as a battery acting through a coil. As seen at A, the lodestone (as found in nature) replaces this outside motivating energy.

While those skilled in the art will probably understand the curves of FIG. 4 without further explanation, the basic operation is as follows, quoting loosely from Van Nostrand:

“When a ferro-magnetic material such as iron is placed in a magnetic field, a certain amount of energy (the battery or the lodestone) is involved in bringing about the magnetic field.

As the field intensity H increases, the magnetic induction B also increases in a manner characteristic of the substance. This is represented by the magnetization curve of FIG. 4. Its initial slope is the initial permeability (μ₀). If H is carried to some maximum value Hₘ and then reduced to −Hₘ, B follows the dotted hysteresis curve. B does not fall off as it was built up (solid lines); the residual induction Bᵣ is the induction remaining when H has been reduced to zero; the reverse H needed to reduce B to zero is called the coercive force (H_{c}). From this point the cycle proceeds to describe the closed curve shown by the dotted lines, which is called the hysteresis loop. (The amount of energy converted into heat is proportional to the area of the cycle.)”

The above details are not needed in order to understand FIG. 3. Note that the rotor armature of the magneto has two offset legs marked N and S. The two poles are similarly offset so that there is but one D.C. wave generation per cycle resulting in a series of half-wave electric current impulses being fed to the battery to produce a charge thereon.

The D. C. motor, which requires very little power, is connected to the magneto rotor armature to produce the required rotation.

A small device of this type could be used, for example, to produce motion of a toy vehicle or operate a clock. (A tiny toy truck manufactured in China by Tinco Toys Co. Ltd. 1/F, Kader Bldg. 22 Jai Chueng Road, Kowloon Bay, Hong Kong operates on an AA 1.5v battery). Thus, a rechargable battery of this type can serve the purpose of this invention. The motor should be provided with a crank to charge the battery initially to a motor driving level.

It can be anticipated that a wide variety of possible energy extracting systems will eventually be found, some necessitating a catalyst, temperature regulator or other conditioning device to serve the purpose demonstrated by the motor in FIG. 3. Also, the storing device, there demonstrated by the battery, could take a very wide variety of forms depending on the substance involved.

1) a method of generating useful energy using a non-combustible, non-radioactive substance which is exothermic or in some other way yields decay energy, which comprises
mounting such substance in or on a device adapted to operate over a predetermined time to extract such energy,
conditioning a storage device to receive such extracted energy,
and applying the stored energy for a useful purpose:

2) A method according to claim 1, wherein
the substance is lodestone.
the storage device is an electric battery,
the energy extracting device is a magneto,
the conditioning device is a motor,
and the using device is a vehicle.

3) A device for generating and using energy from a non-combustible, non-radioactive substance which is exothermic or in some other way yields decay energy, comprising
means for mounting such substance in or on an energy extracting device,
a storage device for receiving the extracted energy,
a conditioning means for rendering said storage device operable,
and means for delivering the stored energy to an energy operated receiver.

4) A device according to claim 3, wherein
said substance comprises lodestone,
said extracting device being a magneto,
said storage device being an electric battery,
said conditioning device being an electric motor adapted to rotate a rotor in the magneto,
and said energy receiving device being a vehicle.
